(19) United States
(12) Patent Application Publication
(10) Pub. No.: US 2024/0151897 A1
(43) Pub. Date: May 9, 2024

(54) MULTI-CORE FIBER, PITCH CONVERTER, OPTICAL FIBER CONNECTION STRUCTURE, AND METHOD OF MANUFACTURING OPTICAL FIBER CONNECTION STRUCTURE

(71) Applicant: FURUKAWA ELECTRIC CO., LTD., Tokyo (JP)

(72) Inventors: Masanori TAKAHASHI, Tokyo (JP); Ryuichi SUGIZAKI, Tokyo (JP)

(73) Assignee: FURUKAWA ELECTRIC CO., LTD., Tokyo (JP)

(21) Appl. No.: 18/413,136

(22) Filed: Jan. 16, 2024

Related U.S. Application Data
(63) Continuation of application No. PCT/JP2022/028521, filed on Jul. 22, 2022.

(30) Foreign Application Priority Data
Jul. 28, 2021 (JP) 2021-123474

(51) Int. Cl. G02B 6/02; G02B 6/38

(52) U.S. Cl. CPC G02B 6/02042; G02B 6/3885

(57) ABSTRACT

A multi-core fiber includes: a plurality of core portions; and a cladding portion surrounding outer circumferences of the plurality of core portions and having a refractive index lower than a maximum refractive index of the plurality of core portions. The multi-core fiber has a mode field diameter of 5 μm or smaller at a wavelength of 1550 nm, the multi-core fiber has a core pitch of 20 μm or smaller, the core pitch being an interval between centers of nearest neighboring ones of the plurality of core portions in a cross section orthogonal to a longitudinal direction. The multi-core fiber has inter-core crosstalk of −20 dB/km or less. The multi-core fiber has a macrobending loss of 0.1 dB/m or less at the wavelength of 1550 nm when the multi-core fiber is bent at a radius of 5 mm.

This application is a continuation of International Application No. PCT/JP2022/028521, filed on Jul. 22, 2022 which claims the benefit of priority of the prior Japanese Patent Application No. 2021-123474, filed on Jul. 28, 2021, the entire contents of which are incorporated herein by reference.

### BACKGROUND

The present disclosure relates to multi-core fibers, pitch converters, optical fiber connection structures, and methods of manufacturing the optical fiber connection structures.

A space division multiplex technique has been developed as a new technique for increasing transmission capacity comparatively inexpensively. Multi-core fibers (MCFs) are an example of such space division multiplex technique (see Takashi Matsui, Taiji Sakamoto, Yukihiro Goto, Kotaro Saito, Kazuhide Nakajima, Fumihiko, Yamamoto, and Toshio Kurashima, “Design of 125 μm cladding multi-core fiber with full-band compatibility to conventional single-mode fiber”, European Conference on Optical Communication 2015, We.1.4.5.). Inter-core crosstalk (XT) is a problem in the type of multi-core fiber disclosed in Takashi Matsui, Taiji Sakamoto, Yukihiro Goto, Kotaro Saito, Kazuhide Nakajima, Fumihiko, Yamamoto, and Toshio Kurashima, “Design of 125 μm cladding multi-core fiber with full-band compatibility to conventional single-mode fiber”, European Conference on Optical Communication 2015, We.1.4.5. because increasing the number of core portions decreases distances between cores.

A multi-core fiber called a coupled multi-core optical fiber has also been disclosed as another type of multi-core fiber (see Tetsuya HAYASHI, Yoshiaki TAMURA, Takemi HASEGAWA, Tetsuya NAKANISHI, and Toshiki TARU, “Coupled Multi-Core Optical Fiber Suitable for Long-Haul Transmission”, SEI TECHNICAL REVIEW, NUMBER 85, OCTOBER 2017, pages 19 to 23). Inter-core crosstalk is permitted in coupled multi-core fibers and coupled multi-core fibers are multi-core fibers having high core densities with reduced distances between their cores. Use of a coupled multi-core fiber in signal transmission and processing of transmitted signal light are premised on multiple input multiple output (MIMO) digital signal processing (DSP). A multi-core fiber without any inter-core crosstalk or with small inter-core crosstalk is sometimes called an uncoupled multi-core fiber.

### SUMMARY

The multi-core fibers with higher core densities and less inter-core crosstalk have not been studied sufficiently and have had room for improvement.

There is a need for a multi-core fiber, a pitch converter, an optical fiber connection structure, and a method of manufacturing the optical fiber connection structure that achieve higher core densities and less inter-core crosstalk.

According to one aspect of the present disclosure, there is provided a multi-core fiber including: a plurality of core portions; and a cladding portion surrounding outer circumferences of the plurality of core portions and having a refractive index lower than a maximum refractive index of the plurality of core portions, wherein the multi-core fiber has a mode field diameter of 5 μm or smaller at a wavelength of 1550 nm, the multi-core fiber has a core pitch of 20 μm or smaller, the core pitch being an interval between centers of nearest neighboring ones of the plurality of core portions in a cross section orthogonal to a longitudinal direction, the multi-core fiber has inter-core crosstalk of −20 dB/km or less, and the multi-core fiber has a macrobending loss of 0.1 dB/m or less at the wavelength of 1550 nm when the multi-core fiber is bent at a radius of 5 mm.

According to another aspect of the present disclosure, there is provided a pitch converter including: a plurality of core portions; a cladding portion surrounding outer circumferences of the plurality of core portions and having a refractive index lower than the maximum refractive index of the plurality of core portions; and a first end face and a second end face that are orthogonal to a longitudinal direction and opposed to each other in the longitudinal direction, wherein the plurality of core portions and the cladding portion have a diameter decreasing portion that decreases in diameter in a tapered form to ⅔ of a diameter or less from the first end face to the second end face, the pitch converter has a core pitch of 30 μm or larger, the core pitch being an interval between centers of nearest neighboring ones of the plurality of core portions at the first end face, and the pitch converter has a core pitch of 20 μm or smaller, the core pitch being an interval between the centers of the nearest neighboring ones of the plurality of core portions at the second end face.

According to still another aspect of the present disclosure, there is provided an optical fiber connection structure including: a first multi-core fiber that includes a plurality of core portions and a cladding portion surrounding outer circumferences of the plurality of core portions and having a refractive index lower than the maximum refractive index of the plurality of core portions, has a core pitch of 20 μm or smaller, the core pitch being an interval between centers of nearest neighboring ones of the plurality of core portions in a cross section orthogonal to a longitudinal direction, and is a coupled multi-core fiber; and a second multi-core fiber that is connected to the first multi-core fiber, includes a plurality of core portions and a cladding portion surrounding outer circumferences of the plurality of core portions and having a refractive index lower than the maximum refractive index of the plurality of core portions, has a core pitch of 20 μm or smaller, the core pitch being an interval between centers of nearest neighboring ones of the plurality of core portions in a cross section orthogonal to a longitudinal direction and being equal to the core pitch of the first multi-core fiber, and is an uncoupled multi-core fiber having inter-core crosstalk of −20 dB/km or less.

### BRIEF DESCRIPTION OF THE DRAWINGS

FIG. 1 is a schematic diagram illustrating a multi-core fiber according to a first embodiment;

FIG. 2A is a schematic diagram of a refractive index profile that is able to be used for the multi-core fiber;

FIG. 2B is a schematic diagram of a refractive index profile that is able to be used for the multi-core fiber;

FIG. 2C is a schematic diagram of a refractive index profile that is able to be used for the multi-core fiber;

FIG. 3 is a schematic diagram illustrating a multi-core fiber according to a second embodiment;

FIG. 4 is a schematic diagram illustrating a pitch converter according to a third embodiment;

FIG. 5 is a schematic diagram illustrating the pitch converter according to the third embodiment;

FIG. 6 is a schematic exploded view of an optical fiber connection structure according to a fourth embodiment;

FIG. 7 is a diagram illustrating an example of a relation between core diameter and mode field diameter;

FIG. 8 is a schematic exploded view of an optical fiber connection structure according to a fifth embodiment;

FIG. 9 is a schematic exploded view of an optical fiber connection structure according to a sixth embodiment; and

FIG. 10 is a schematic exploded view of an optical fiber connection structure according to a seventh embodiment.

### DETAILED DESCRIPTION

Embodiments of the present disclosure will be described hereinafter by reference to the drawings. The present disclosure is not limited by these embodiments. The same reference sign will be assigned to elements that are the same or corresponding to each other, as appropriate, throughout the drawings. It also needs to be noted that the drawings are schematic, and relations among dimensions of each element and ratios among different elements, for example, may be different from the actual ones. A portion having different dimensional relations and ratios among the drawings may also be included. In this specification, a cutoff wavelength means a cable cutoff wavelength that is an effective cutoff wavelength and defined by G.650.1 of the International Telecommunication Union (ITU-T). Any other term not particularly defined in this specification conforms to the definitions or measurement methods according to G.650.1 and G.650.2.

### First Embodiment

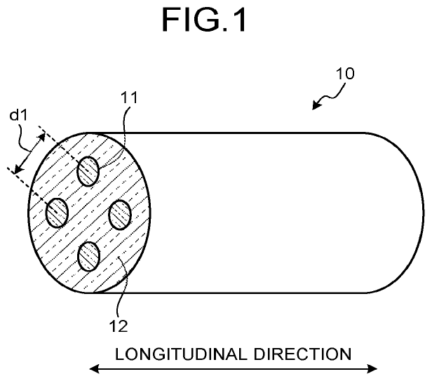

FIG. 1 is a schematic diagram illustrating a multi-core fiber according to a first embodiment. A multi-core fiber 10 includes a plurality of core portions 11, a cladding portion 12 surrounding the outer circumferences of the plurality of core portions 11 and having a refractive index lower than the maximum refractive index of the plurality of core portions 11, and extends in a longitudinal direction. The multi-core fiber 10 has a structure with four core portions 11 being inside the cladding portion 12 and being arranged in a square lattice form in a cross section orthogonal to the longitudinal direction. The core portions 11 are an example of four or more core portions arranged in a square lattice form.

The core portions 11 are formed of silica-based glass having a dopant added therein, the dopant being for adjusting the refractive index and being, for example, germanium or fluorine. The cladding portion 12 is formed of, for example, pure silica glass. Pure silica glass herein refers to extremely pure silica glass substantially not including a dopant that changes its refractive index and having a refractive index of about 1.444 at a wavelength of 1550 nm.

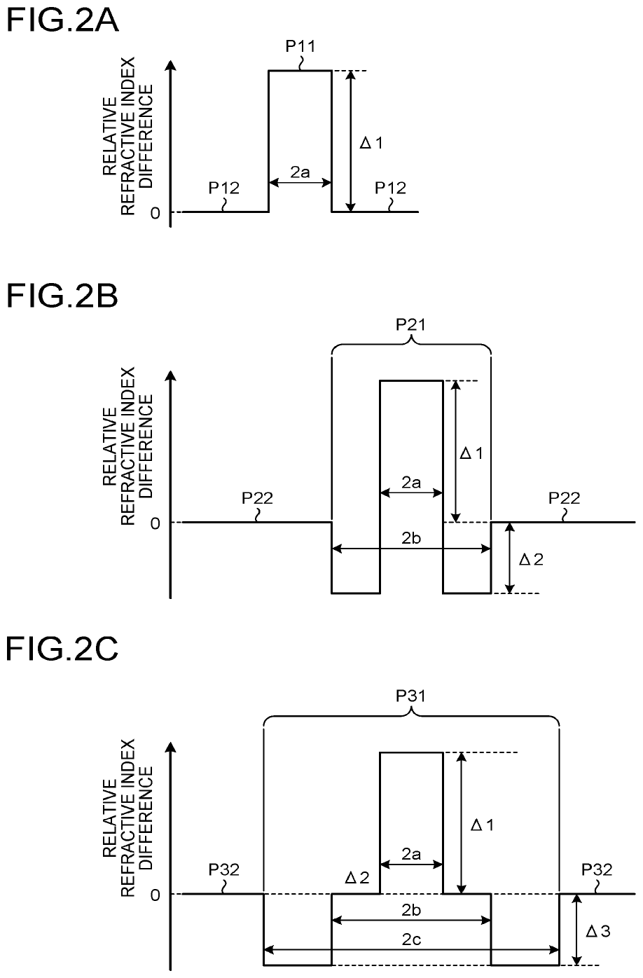

The core portions 11 of the multi-core fiber 10 have, for example, a refractive index profile like that illustrated in FIG. 2A, 2B, or 2C.

FIG. 2A is a step-shaped refractive index profile. In FIG. 2A, a profile P11 represents a refractive index profile of the plurality of core portions 11 that are center cores and a profile P12 represents a refractive index profile of the cladding portion 12. The refractive index profiles are represented by relative refractive index differences (Δ) with respect to the cladding portion 12. According to the step-shaped refractive index profile illustrated in FIG. 2A, the core portions 11 have a diameter (core diameter) of 2a and a relative refractive index difference of Δ1 with respect to the cladding portion 12.

FIG. 2B illustrates a W-shaped refractive index profile. In FIG. 2B, a profile P21 represents a refractive index profile of the plurality of core portions 11 and a profile P22 represents a refractive index profile of the cladding portion 12. According to the W-shaped refractive index profile, the core portions 11 are each formed of: a center core having a diameter of 2a; and a depressed layer surrounding the outer circumference of the center core, having a refractive index smaller than that of the cladding portion 12, and having an inner diameter of 2a and an outer diameter of 2b. The center core has a relative refractive index difference of Δ1 with respect to the cladding portion 12. The depressed layer has a relative refractive index difference of Δ2 with respect to the cladding portion 12.

FIG. 2C illustrates a trench-shaped refractive index profile. In FIG. 2C, a profile P31 represents a refractive index profile of the plurality of core portions 11 and a profile P32 represents a refractive index profile of the cladding portion 12. According to the trench-shaped refractive index profile, the core portions 11 are each formed of: a center core having a diameter of 2a; an intermediate layer surrounding the outer circumference of the center core, having a refractive index smaller than that of the center core, and having an inner diameter of 2a and an outer diameter of 2b; and a trench layer surrounding the outer circumference of the intermediate layer, having a refractive index smaller than that of the cladding portion 12, and having an inner diameter of 2b and an outer diameter of 2c. The center core has a relative refractive index difference of Δ1 with respect to the intermediate layer. The intermediate layer has a relative refractive index difference of Δ2 with respect to the cladding portion 12. Usually, Δ2 is set to 0% or around 0%, for example, in a range of −0.2% to 0.2%. The trench layer has a relative refractive index difference of Δ3 with respect to the cladding portion 12.

Reference will now be made to FIG. 1 again. A core pitch d1 in the multi-core fiber 10 is an interval between the centers of the nearest neighboring ones of the plurality of core portions 11 in the cross section orthogonal to the longitudinal direction. The core pitch d1 in the multi-core fiber 10 is 20 μm or smaller.

Inter-core crosstalk in the multi-core fiber 10 is crosstalk between the nearest neighboring two of the plurality of core portions 11 at a wavelength of 1625 nm. The inter-core crosstalk for the core portions 11 in the multi-core fiber 10 is −20 dB/km or less. That is, the multi-core fiber 10 is an uncoupled multi-core fiber.

The multi-core fiber 10 has a macrobending loss of 0.1 dB/m or less at the wavelength of 1550 nm when the core portions 11 are bent at a radius of 5 mm.

The multi-core fiber 10 configured as described above has the inter-core crosstalk reduced to −20 dB/km or less while having an increased core density with the core pitch d1 being 20 μm or smaller. Furthermore, the multi-core fiber 10 is high in bending resistance and is thus suitable for uses in comparatively short distance connection of, for example, wiring in devices.

To achieve the core pitch d1 of 20 μm or smaller and inter-core crosstalk of −20 dB/km or less in the multi-core fiber 10, for example, the core portions 11 preferably have a mode field diameter (MFD) of 5 μm or smaller at the wavelength of 1550 nm and the maximum refractive index of the plurality of core portions 11 preferably has a relative refractive index difference, that is, Δ1 of 2% or more with respect to the refractive index of the cladding portion.

The multi-core fiber 10 is able to be manufactured by use of various publicly known methods for manufacturing multi-core fibers, such as the drilling method.

According to results of simulation calculation executed by the inventors of the present disclosure, in a case where Δ1 is 2.0%, the mode field diameter is 4.4 μm at the wavelength of 1550 nm, 2a (core diameter) is 3.5 μm, and the core pitch is 20 μm for the step-shaped refractive index profile; crosstalk (XT) between cores of −51.5 dB per meter, that is, inter-core crosstalk of −21.5 dB/km is obtained. To reduce the inter-core crosstalk to −20 dB/km or less in the case where the core pitch is 20 μm, desirably, the mode field diameter at the wavelength of 1550 nm is in a range of 4.0 μm or larger and 4.8 μm or smaller, the core diameter (2a) is in a range of 3.2 μm or larger and 3.7 μm or smaller, and Δ1 is in a range of 1.9% or more and 2.3% or less.

Furthermore, according to results of simulation calculation, in a case where Δ1 is 2.0%, Δ2 is −0.55%, the mode field diameter is 4.1 μm at the wavelength of 1550 nm, 2a is 3.8 μm, 2b is 9.8 μm, and the core pitch is 20 μm for the W-shaped refractive index profile; inter-core crosstalk of −54.4 dB per meter, that is, inter-core crosstalk of −24.4 dB/km is obtained. To reduce the inter-core crosstalk to −20 dB/km or less in the case where the core pitch is 20 μm, desirably, the mode field diameter at the wavelength of 1550 nm is in a range of 4.0 μm or larger and 4.4 μm or smaller, Δ1 is in a range of 1.8% or more and 2.3% or less, Δ2 is in a range of −0.67% or more and −0.53% or less, the core diameter (2a) is in a range of 3.5 μm or larger and 4.1 μm or smaller, and 2b is in a range of 9.5 μm or larger and 10.1 μm or smaller.

Furthermore, according to results of simulation calculation, in a case where Δ1 is 2.0%, Δ2 is 0%, Δ3 is −0.55%, the mode field diameter is 4.1 μm at the wavelength of 1550 nm, 2a is 3.5 μm, 2b is 6.3 μm, 2c is 9.8 μm, and the core pitch is 20 μm for the trench-shaped refractive index profile; inter-core crosstalk of −54.4 dB per meter, that is, inter-core crosstalk of −24.4 dB/km is obtained. To reduce the inter-core crosstalk to −20 dB/km or less in the case where the core pitch is 20 μm, desirably, the mode field diameter at the wavelength of 1550 nm is in a range of 4.0 μm or larger and 4.3 μm or smaller, Δ1 is in a range of 1.8% or more and 2.3% or less, Δ2 is in a range of −0.05% or more and 0.05% or less, the core diameter (2a) is in a range of 3.3 μm or larger and 3.7 μm or smaller, 2b is in a range of 6.0 μm or larger and 6.5 μm or smaller, and 2c is in a range of 9.6 μm or larger and 10.0 μm or smaller.

### Second Embodiment

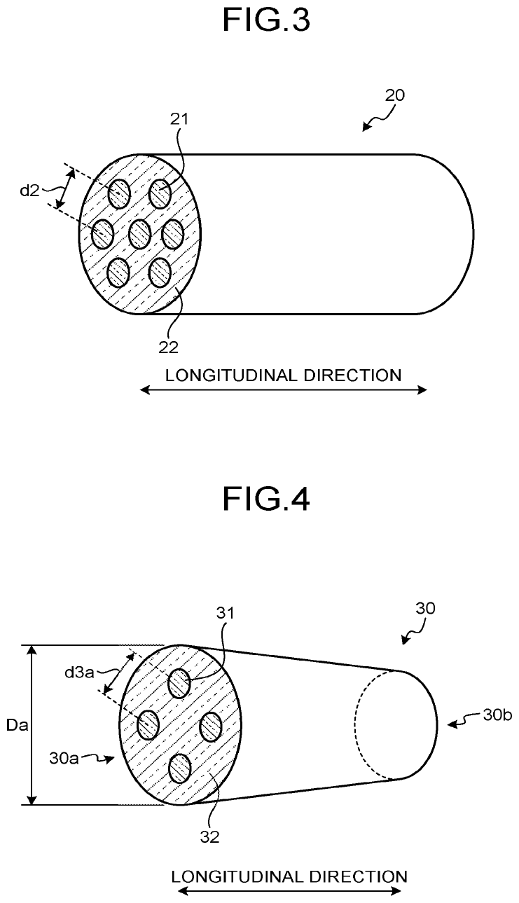

FIG. 3 is a schematic diagram illustrating a multi-core fiber according to a second embodiment. A multi-core fiber 20 includes a plurality of core portions 21 and a cladding portion 22 surrounding the outer circumferences of the plurality of core portions 21 and having a refractive index lower than the maximum refractive index of the plurality of core portions 21, and extends in a longitudinal direction. This multi-core fiber 20 has a structure with seven core portions 21 being inside the cladding portion 22 and being arranged in a hexagonal close-packed lattice form in a cross section orthogonal to the longitudinal direction. The core portions 21 are an example of three or more core portions arranged in a hexagonal close-packed lattice form.

Materials composing the core portions 21, a material composing the cladding portion 22, and the refractive index profile are the same as those of the corresponding elements of the multi-core fiber 10 and description thereof will thus be omitted.

A core pitch d2 in the multi-core fiber 20 is an interval between the centers of the nearest neighboring ones of the plurality of core portions 21 in the cross section orthogonal to the longitudinal direction. The core pitch d2 in the multi-core fiber 20 is 20 μm or smaller.

Inter-core crosstalk for the core portions 21 in the multi-core fiber 20 is −20 dB/km or less.

The multi-core fiber 20 has a macrobending loss of 0.1 dB/m or less at a wavelength of 1550 nm when the core portions 21 are bent at a radius of 5 mm.

The multi-core fiber 20 configured as described above has the inter-core crosstalk reduced to −20 dB/km or less while having an increased core density with the core pitch d2 being 20 μm or smaller. Furthermore, the multi-core fiber 20 is high in bending resistance and is thus suitable for uses in comparatively short distance connection of, for example, wiring in devices.

To achieve the core pitch d2 of 20 μm or smaller and inter-core crosstalk of −20 dB/km or less in the multi-core fiber 20, for example, the core portions 21 preferably have a mode field diameter of 5 μm or smaller at the wavelength of 1550 nm and the maximum refractive index of the plurality of core portions 11 preferably has a relative refractive index difference, that is, Δ1 of 2% or more with respect to the refractive index of the cladding portion 22.

Such technique related to multi-core fibers with reduced inter-core crosstalk and higher core densities is applicable to a pitch converter and an optical fiber connection structure like those in embodiments described hereinafter.

### Third Embodiment

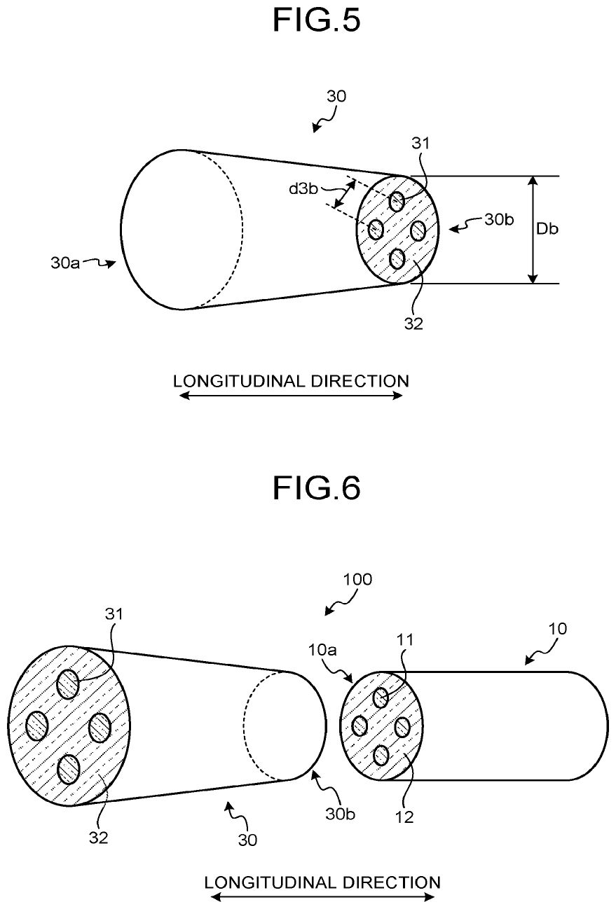

FIG. 4 and FIG. 5 are schematic diagrams illustrating a pitch converter according to a third embodiment. A pitch converter 30 includes a plurality of core portions 31 and a cladding portion 32 surrounding the outer circumferences of the plurality of core portions 31 and having a refractive index lower than the maximum refractive index of the plurality of core portions 31, and extends in a longitudinal direction. Furthermore, the pitch converter 30 includes a first end face 30a and a second end face 30b that are orthogonal to the longitudinal direction and opposed to each other in the longitudinal direction. The core portions 31 and the cladding portion 32 are exposed at the first end face 30a and the second end face 30b.

The pitch converter 30 has a structure with four core portions 31 being inside the cladding portion 32 and being arranged in a square lattice form in a cross section orthogonal to the longitudinal direction.

Materials composing the core portions 31, a material composing the cladding portion 32, and the refractive index profile are the same as those of the corresponding elements of the multi-core fiber 10 and description thereof will thus be omitted.

The core portions 31 and the cladding portion 32 have a diameter decreasing portion that decreases in diameter in a tapered form up to ⅔ or less of the diameter from the first end face 30a to the second end face 30b in the longitudinal direction. In this embodiment, the diameter decreasing portion extends over the entire length from the first end face 30a to the second end face 30b. That is, a diameter Db of the cladding portion 32 at the second end face 30b is ⅔ or less of a diameter Da of the cladding portion 32 at the first end face 30a. The diameter Db of the cladding portion 32 at the second end face 30b is, for example, 70 μm or larger and 125 μm or smaller.

In the pitch converter 30, a core pitch d3a at the first end face 30a is 30 μm or larger and a core pitch d3b at the second end face 30b is 20 μm or smaller.

The pitch converter 30 is able to be suitably used for connection between multi-core fibers having different core pitches. For example, the pitch converter 30 may be configured to have the core portions 31 and the cladding portion 32 that decrease in diameter in a tapered form up to ⅔ of the diameter from the first end face 30a to the second end face 30b in the longitudinal direction, with the core pitch d3a being 30 μm and the core pitch d3b being 20 μm. As a result, the pitch converter 30 serves as a pitch converter that enables good connection between a multi-core fiber having a core pitch of 30 μm and a multi-core fiber having a core pitch of 20 μm.

The pitch converter 30 may be manufactured as follows, for example. That is, a multi-core fiber having a configuration similar to that of the multi-core fiber 10 according to the first embodiment but different therefrom in that the multi-core fiber has a core pitch of 30 μm is heated to be stretched in a tapered form and formed into the pitch converter 30. If a pitch converter shorter in length is preferable, the tapered portion may be cut out and formed into the pitch converter 30. In this case, the multi-core fiber preferably has a mode field diameter of 5 μm or smaller at a wavelength of 1550 nm for the core portions and Δ1 is preferably 2% or more. In the pitch converter 30 manufactured from such a multi-core fiber, Δ1 is 2% or more for the core portions.

### Fourth Embodiment

FIG. 6 is a schematic exploded view of an optical fiber connection structure according to a fourth embodiment. An optical fiber connection structure 100 has an end face 10a of the multi-core fiber 10 according to the first embodiment and the second end face 30b of the pitch converter 30 according to the third embodiment connected to each other, and the four core portions 11 and the four core portions 31 respectively connected to each other. The connection is achieved by, for example, fusion splicing, but may be achieved by physical contact instead. The multi-core fiber 10 is an example of a connecting multi-core fiber.

This optical fiber connection structure 100 is able to be connected, for example, to both of two multi-core fibers having core pitches different from each other. For example, the optical fiber connection structure 100 is able to be connected to both a multi-core fiber having a core pitch of 30 μm and a multi-core fiber having a core pitch of 20 μm.

According to results of simulation calculation executed by the inventors, the optical fiber connection structure 100 has, for example, properties listed in Table 1. In Table 1, “HΔMCF” is the multi-core fiber 10 and “pitch converter” is the pitch converter 30. In the pitch converter 30, “smaller pitch end” is an end at the second end face 30b and “larger pitch end” is an end at the first end face 30a. Both the multi-core fiber 10 and the pitch converter 30 were set to have a step-shaped refractive index profile.

In a case where the multi-core fiber 10 (HΔMCF) has Δ1 of 2.0%, a mode field diameter of 4.4 μm at a wavelength of 1550 nm, a core diameter (2a) of 3.5 μm, and a core pitch of 20 μm; inter-core crosstalk of −51.5 dB per meter, that is, inter-core crosstalk of −21.5 dB/km is obtained. The cutoff wavelength λc is 1239 nm.

The pitch converter 30 has a multi-core fiber having Δ1 of 2.0%, a mode field diameter of 4.4 μm at the wavelength of 1550 nm, a core diameter (2a) of 3.5 μm, and a core pitch of 30 μm, the multi-core fiber decreasing in diameter in a tapered form to ⅔ of its diameter from the first end face 30a (larger pitch end) to the second end face 30b (smaller pitch end), with the core pitch d3a being 30 μm and the core pitch d3b being 20 μm. In this case, at the larger pitch end, the core diameter (2a) is 3.5 μm, the mode field diameter is 4.4 μm, and the cutoff wavelength λc is 1239 nm, and inter-core crosstalk of −115.9 dB per meter is obtained. At the smaller pitch end, the core diameter (2a) is 2.3 μm, the mode field diameter is 4.6 μm, and the cutoff wavelength λc is 894 nm, and inter-core crosstalk of −22.7 dB per meter is obtained.

However, in the multi-core fiber 10 (HΔMCF) and at the first end face 30a (larger pitch end), the core diameter (2a) may be in a range of 3.2 μm or larger and 3.7 μm or smaller and Δ1 may be in a range of 1.9% or more and 2.3% or less.

TABLE 1

| | | Pitch converter | |
|---|---|---|---|
| | HΔMCF | Smaller pitch end | Larger pitch end |
| Core pitch (μm) | 20 | 20 | 30 |
| Δ1 (%) | 2.0 | 2.0 | 2.0 |
| Core diameter | 3.5 | 2.3 | 3.5 |
| (μm) | | | |
| MFD (μm) | 4.4 | 4.6 | 4.4 |
| λc (nm) | 1239 | 894 | 1239 |
| XT (dB) | −51.5 | −22.7 | −115.9 |

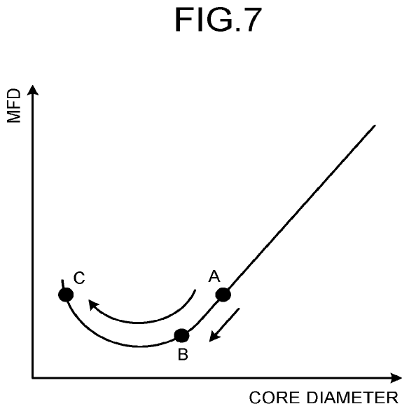

The core diameter and the mode field diameter of a multi-core fiber before the multi-core fiber is stretched have a relation indicated by Point A in FIG. 7, but when the multi-core fiber is heated and stretched in a tapered form, due to the decrease in the core diameter, the mode field diameter may sometimes be decreased as represented by Point B in FIG. 7. However, when the core diameter is decreased further, confinement of light by the core portions is reduced and the mode field diameter is then actually increased as represented by Point C in FIG. 7. The pitch converter in Table 1 has been decreased in core diameter, at the smaller pitch end, to an extent that allows the mode field diameter to be increased with the decrease in core diameter. Increase in the connection loss due to mode field mismatch between the smaller pitch end of the pitch converter 30 and the multi-core fiber 10 (HΔMCF) is thereby able to be minimized.

### Fifth Embodiment

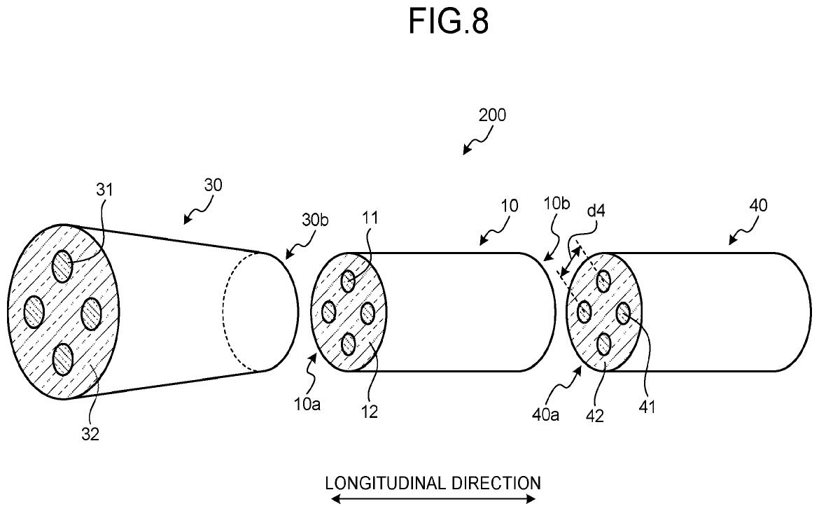

FIG. 8 is a schematic exploded view of an optical fiber connection structure according to a fifth embodiment. An optical fiber connection structure 200 has the end face 10a of the multi-core fiber 10 according to the first embodiment and the second end face 30b of the pitch converter 30 according to the third embodiment connected to each other, as well as an end face 10b of the multi-core fiber 10 and an end face 40a of a coupled multi-core fiber 40 connected to each other. The connection is achieved by, for example, fusion splicing, but may be achieved by physical contact instead.

The coupled multi-core fiber 40 includes a plurality of core portions 41 and a cladding portion 42 surrounding the outer circumferences of the plurality of core portions 41 and having a refractive index lower than the maximum refractive index of the plurality of core portions 41, and extends in a longitudinal direction. This coupled multi-core fiber 40 has a structure with four core portions 11 being inside the cladding portion 42 and being arranged in a square lattice form in a cross section orthogonal to the longitudinal direction. The core portions 41 are an example of four or more core portions arranged in a square lattice form.

Materials composing the core portions 41, a material composing the cladding portion 42, and the refractive index profile are the same as those of the corresponding elements of the multi-core fiber 10 and description thereof will thus be omitted.

A core pitch d4 in the coupled multi-core fiber 40 is an interval between the centers of the nearest neighboring ones of the plurality of core portions 41 in the cross section orthogonal to the longitudinal direction. The core pitch d4 in the coupled multi-core fiber 40 is 20 μm or smaller. The core pitch d1 of the multi-core fiber 10 and the core pitch d4 of the coupled multi-core fiber 40 are equal to each other.

In the optical fiber connection structure 200, the four core portions 11 and the four core portions 31 are respectively connected to each other, and the four core portions 11 and the four core portions 41 are respectively connected to each other.

The multi-core fiber 10 and the coupled multi-core fiber 40 are connected to each other to form an optical fiber connection structure. The coupled multi-core fiber 40 is an example of a first multi-core fiber. The multi-core fiber 10 is an uncoupled multi-core fiber and is an example of a second multi-core fiber.

The multi-core fiber 10 and the coupled multi-core fiber 40 preferably have approximately the same cladding diameter. For example, their cladding diameters are 125 μm±1 μm (1 μm is a common difference) and may have a difference of about 2 μm from each other.

In connecting the multi-core fiber 10 and the coupled multi-core fiber 40 to each other, preferably, the multi-core fiber 10 and the coupled multi-core fiber 40 are fusion spliced and the fusion spliced portion is additionally heated so that the mode field diameter of the plurality of core portions 11 of the multi-core fiber 10 and the mode field diameter of the plurality of core portions 41 of the coupled multi-core fiber 40 become close to each other. Connection loss between the multi-core fiber 10 and the coupled multi-core fiber 40 is thereby able to be reduced.

According to results of simulation calculation executed by the inventors, the optical fiber connection structure 200 has, for example, properties listed in Table 2. In Table 2, “HΔMCF” is the multi-core fiber 10, “C-MCF” is the coupled multi-core fiber 40, and “pitch converter” is the pitch converter 30. The multi-core fiber 10, the coupled multi-core fiber 40, and the pitch converter 30 were all set to have a step-shaped refractive index profile.

In a case where the multi-core fiber 10 (HΔMCF) has Δ1 of 2.0%, a mode field diameter of 4.4 μm at a wavelength of 1550 nm, a core diameter (2a) of 3.5 μm, and a core pitch of 20 μm; inter-core crosstalk of −51.5 dB per meter, that is, inter-core crosstalk of −21.5 dB/km is obtained. The cutoff wavelength λc is 1239 nm.

In a case where the coupled multi-core fiber 40 (C-MCF) has Δ1 of 0.38%, a mode field diameter of 9.0 μm at the wavelength of 1550 nm, 2a of 8.6 μm, and a core pitch of 20 μm; properties of a coupled multi-core fiber were obtained. Because a mode field diameter per core portion is unable to be defined for a coupled multi-core fiber, the above mentioned mode field diameter is a mode field diameter of a single core fiber having a core diameter, Δ1, and a refractive index profile that are the same as those mentioned above. The cutoff wavelength λc is 1230 nm.

The pitch converter 30 has a multi-core fiber having Δ1 of 2.0%, a mode field diameter of 4.4 μm at the wavelength of 1550 nm, a core diameter (2a) of 3.5 μm, and a core pitch of 30 μm, the multi-core fiber decreasing in diameter in a tapered form to ⅔ of its diameter from the first end face 30a (larger pitch end) to the second end face 30b (smaller pitch end), with the core pitch d3a being 30 μm and the core pitch d3b being 20 μm. In this case, at the larger pitch end, 2a is 3.5 μm, the mode field diameter is 4.4 μm, and the cutoff wavelength λc is 1239 nm, and inter-core crosstalk of −115.9 dB per meter is obtained. At the smaller pitch end, 2a is 2.3 μm, the mode field diameter is 4.6 μm, and the cutoff wavelength λc is 894 nm, and inter-core crosstalk of −22.7 dB per meter is obtained.

However, in the multi-core fiber 10 (HΔMCF) and at the first end face 30a (larger pitch end) of the pitch converter 30, the core diameter (2a) may be in a range of 3.2 μm or larger and 3.7 μm or smaller and Δ1 may be in a range of 1.9% or more and 2.3% or less.

TABLE 2

| | | | Pitch converter | |
|---|---|---|---|---|
| | | | Smaller pitch | Larger pitch |
| | C-MCF | HΔMCF | end | end |
| Core pitch (μm) | 20 | 20 | 20 | 30 |
| Δ1 (%) | 0.38 | 2.0 | 2.0 | 2.0 |
| 2a (μm) | 8.6 | 3.5 | 2.3 | 3.5 |
| MFD (μm) | 9.0 | 4.4 | 4.6 | 4.4 |
| λc (nm) | 1230 | 1239 | 894 | 1239 |
| XT (dB) | — | −51.5 | −22.7 | −115.9 |

According to results of simulation calculation, the optical fiber connection structure 200 has, for example, properties listed in Table 3. Both the multi-core fiber 10 and the pitch converter 30 were set to have a W-shaped refractive index profile.

In a case where the multi-core fiber 10 (HΔMCF) has Δ1 of 2.0%, Δ2 of −0.55%, a mode field diameter of 4.1 μm at the wavelength of 1550 nm, 2a of 3.8 μm, 2b of 9.8 μm, and a core pitch of 20 μm; inter-core crosstalk of −54.4 dB per meter, that is, inter-core crosstalk of −24.4 dB/km is obtained. The cutoff wavelength λc is 1218 nm.

The results for the coupled multi-core fiber 40 (C-MCF) are the same as those in Table 2 and description thereof will thus be omitted.

The pitch converter 30 has a multi-core fiber having Δ1 of 2.0%, Δ2 of −0.55%, a mode field diameter of 4.1 μm at the wavelength of 1550 nm, 2a of 3.8 μm, 2b of 9.8 μm, and a core pitch of 30 μm, the multi-core fiber decreasing in diameter in a tapered form to ⅔ of its diameter from the first end face 30a (larger pitch end) to the second end face 30b (smaller pitch end), with the core pitch d3a being 30 μm and the core pitch d3b being 20 μm. In this case, at the larger pitch end, 2a is 3.8 μm, 2b is 9.8 μm, the mode field diameter is 4.1 μm, and the cutoff wavelength λc is 1218 nm, and inter-core crosstalk of −124.1 dB per meter is obtained. At the smaller pitch end, 2a is 2.5 μm, 2b is 6.5 μm, the mode field diameter is 4.3 μm, and the cutoff wavelength λc is 817 nm, and inter-core crosstalk of −23.6 dB per meter is obtained. The pitch converter in Table 3 has also been decreased in core diameter, at the smaller pitch end, to an extent that allows the mode field diameter to be increased with the decrease in core diameter.

However, in the multi-core fiber 10 (HΔMCF) and at the first end face 30a (larger pitch end) of the pitch converter 30, Δ1 may be in a range of 1.8% or more and 2.3% or less, Δ2 may be in a range of −0.67% or more and −0.53% or less, the core diameter (2a) may be in a range of 3.5 μm or larger and 4.1 μm or smaller, and 2b may be in a range of 9.5 μm or larger and 10.1 μm or smaller.

TABLE 3

| | | | Pitch converter | |
|---|---|---|---|---|
| | | | Smaller pitch | Larger pitch |
| | C-MCF | HΔMCF | end | end |
| Core pitch (μm) | 20 | 20 | 20 | 30 |
| Δ1 (%) | 0.38 | 2.0 | 2.0 | 2.0 |
| Δ2 (%) | — | −0.55 | −0.55 | −0.55 |
| 2a (μm) | — | 3.8 | 2.5 | 3.8 |
| 2b (μm) | — | 9.8 | 6.5 | 9.8 |
| MFD (μm) | 9.0 | 4.1 | 4.3 | 4.1 |
| λc (nm) | 1230 | 1218 | 817 | 1218 |
| XT (dB) | — | −54.4 | −23.6 | −124.1 |

According to results of simulation calculation, the optical fiber connection structure 200 has, for example, properties listed in Table 4. Both the multi-core fiber 10 and the pitch converter 30 were set to have a trench-shaped refractive index profile.

In a case where the multi-core fiber 10 (HΔMCF) has Δ1 of 2.0%, Δ2 of 0%, Δ3 of −0.55%, a mode field diameter of 4.1 μm at the wavelength of 1550 nm, 2a of 3.5 μm, 2b of 6.3 μm, 2c of 9.8 μm, and a core pitch of 20 μm, inter-core crosstalk of −54.4 dB per meter, that is, inter-core crosstalk of −24.4 dB/km is obtained. The cutoff wavelength λc is 1218 nm.

The results for the coupled multi-core fiber 40 (C-MCF) are the same as those in Table 2 and description thereof will thus be omitted.

The pitch converter 30 has a multi-core fiber having Δ1 of 2.0%, Δ2 of 0%, Δ3 of −0.55%, a mode field diameter of 4.1 μm at the wavelength of 1550 nm, 2a of 3.5 μm, 2b of 6.3 μm, 2c of 9.8 μm, and a core pitch of 30 μm, the multi-core fiber decreasing in diameter in a tapered form to ⅔ of its diameter from the first end face 30a (larger pitch end) to the second end face 30b (smaller pitch end), with the core pitch d3a being 30 μm and the core pitch d3b being 20 μm. In this case, at the larger pitch end, 2a is 3.5 μm, 2b is 6.3 μm, 2c is 9.8 μm, the mode field diameter is 4.1 μm, and the cutoff wavelength λc is 1218 nm, and inter-core crosstalk of −124.1 dB per meter is obtained. At the smaller pitch end, 2a is 2.3 μm, 2b is 4.1 μm, 2c is 6.4 μm, the mode field diameter is 4.3 μm, and the cutoff wavelength λc is 817 nm, and inter-core crosstalk of −23.6 dB per meter is obtained. The pitch converter in Table 4 has also been decreased in core diameter, at the smaller pitch end, to an extent that allows the mode field diameter to be increased with the decrease in core diameter.

However, in the multi-core fiber 10 (HΔMCF) and at the first end face 30a (larger pitch end) of the pitch converter 30, Δ1 may be in a range of 1.8% or more and 2.3% or less, Δ2 may be in a range of −0.05% or more and 0.05% or less, the core diameter (2a) may be in a range of 3.3 μm or larger and 3.7 μm or smaller, 2b may be in a range of 6.0 μm or larger and 6.5 μm or smaller, and 2c may be in a range of 9.6 μm or larger and 10.0 μm or smaller.

TABLE 4

| | | | Pitch converter | |
|---|---|---|---|---|
| | | | Smaller pitch | Larger pitch |
| | C-MCF | HΔMCF | end | end |
| Core pitch (μm) | 20 | 20 | 20 | 30 |
| Δ1 (%) | 0.38 | 2.0 | 2.0 | 2.0 |
| Δ2 (%) | — | 0 | 0 | 0 |
| Δ3 (%) | — | −0.55 | −0.55 | −0.55 |
| 2a (μm) | — | 3.5 | 2.3 | 3.5 |
| 2b (μm) | — | 6.3 | 4.1 | 6.3 |
| 2c (μm) | — | 9.8 | 6.4 | 9.8 |
| MFD (μm) | 9.0 | 4.1 | 4.3 | 4.1 |
| λc (nm) | 1230 | 1218 | 817 | 1218 |
| XT (dB) | — | −54.4 | −23.6 | −124.1 |

### Sixth Embodiment

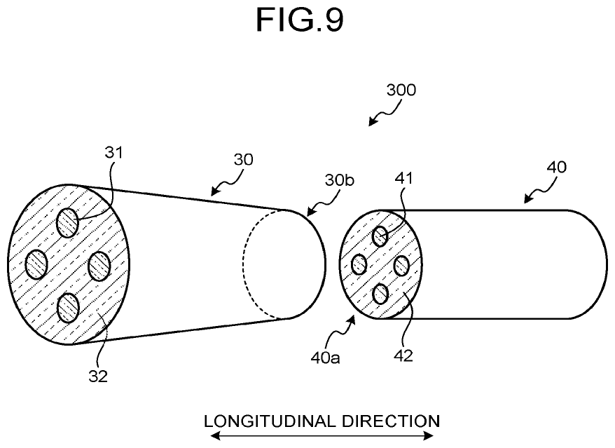

FIG. 9 is a schematic exploded view of an optical fiber connection structure according to a sixth embodiment. An optical fiber connection structure 300 has the end face 40a of the coupled multi-core fiber 40 according to the fifth embodiment and the second end face 30b of the pitch converter 30 according to the third embodiment connected to each other, and the four core portions 41 and the four core portions 31 respectively connected to each other. The connection is achieved by, for example, fusion splicing, but may be achieved by physical contact instead. Like this optical fiber connection structure 300, the coupled multi-core fiber 40 and the pitch converter 30 may be directly connected to each other.

The cladding diameter at the second end face 30b of the pitch converter 30 and the cladding diameter of the coupled multi-core fiber 40 are preferably approximately the same. For example, their cladding diameters are 125 μm±1 μm (1 μm is a common difference) and may have a difference of about 2 μm from each other.

According to results of simulation calculation executed by the inventors, the optical fiber connection structure 300 has, for example, properties listed in Table 5. In Table 5, “C-MCF” is the coupled multi-core fiber 40 and “pitch converter” is the pitch converter 30. Both the coupled multi-core fiber 40 and the pitch converter 30 were set to have a step-shaped refractive index profile.

Results for both the coupled multi-core fiber 40 (C-MCF) and the pitch converter 30 in Table 5 are the same as those in Table 2 and description thereof will thus be omitted.

However, at the first end face 30a (larger pitch end) of the pitch converter 30, the core diameter (2a) may be in a range of 3.2 μm or larger and 3.7 μm or smaller and Δ1 may be in a range of 1.9% or more and 2.3% or less.

TABLE 5

| | | Pitch converter | |
|---|---|---|---|
| | | Smaller pitch | Larger pitch |
| | C-MCF | end | end |
| Core pitch (μm) | 20 | 20 | 30 |
| Δ1 (%) | 0.38 | 2.0 | 2.0 |
| Core diameter (μm) | 8.6 | 2.3 | 3.5 |
| MFD (μm) | 9.0 | 4.6 | 4.4 |
| λc (nm) | 1230 | 894 | 1239 |
| XT (dB) | — | −22.7 | −115.9 |

According to results of simulation calculation, the optical fiber connection structure 300 has, for example, properties listed in Table 6. The pitch converter 30 was set to have a W-shaped refractive index profile.

Results for both the coupled multi-core fiber 40 (C-MCF) and the pitch converter 30 in Table 6 are the same as those in Table 3 and description thereof will thus be omitted.

However, at the first end face 30a (larger pitch end) of the pitch converter 30, Δ1 may be in a range of 1.8% or more and 2.3% or less, Δ2 may be in a range of −0.67% or more and −0.53% or less, the core diameter (2a) may be in a range of 3.5 μm or larger and 4.1 μm or smaller, and 2b may be in a range of 9.5 μm or larger and 10.1 μm or smaller.

TABLE 6

| | | Pitch converter | |
|---|---|---|---|
| | C-MCF | Smaller pitch end | Larger pitch end |
| Core pitch (μm) | 20 | 20 | 30 |
| Δ1 (%) | 0.38 | 2.0 | 2.0 |
| Δ2 (%) | — | −0.55 | −0.55 |
| 2a (μm) | — | 2.5 | 3.8 |
| 2b (μm) | — | 6.5 | 9.8 |
| MFD (μm) | 9.0 | 4.3 | 4.1 |
| λc (nm) | 1230 | 817 | 1218 |
| XT (dB) | — | −23.6 | −24.1 |

According to results of simulation calculation, the optical fiber connection structure 300 has, for example, properties listed in Table 7. The pitch converter 30 was set to have a trench-shaped refractive index profile.

Results for both the coupled multi-core fiber 40 (C-MCF) and the pitch converter 30 in Table 7 are the same as those in Table 4 and description thereof will thus be omitted.

However, at the first end face 30a (larger pitch end) of the pitch converter 30, Δ1 may be in a range of 1.8% or more and 2.3% or less, Δ2 may be in a range of −0.05% or more and 0.05% or less, the core diameter (2a) may be in a range of 3.3 μm or larger and 3.7 μm or smaller, 2b may be in a range of 6.0 μm or larger and 6.5 μm or smaller, and 2c may be in a range of 9.6 μm or larger and 10.0 μm or smaller.

TABLE 7

| | | Pitch converter | |
|---|---|---|---|
| | C-MCF | Smaller pitch end | Larger pitch end |
| Core pitch (μm) | 20 | 20 | 30 |
| Δ1 (%) | 0.38 | 2.0 | 2.0 |
| Δ2 (%) | — | 0 | 0 |
| Δ3 (%) | | -0.55 | -0.55 |
| 2a (μm) | — | 2.3 | 3.5 |
| 2b (μm) | — | 4.1 | 6.3 |
| 2c (μm) | | 6.4 | 9.8 |
| MFD (μm) | 9.0 | 4.3 | 4.1 |
| λc (nm) | 1230 | 817 | 1218 |
| XT (dB) | - | -23.6 | -124.1 |

### Seventh Embodiment

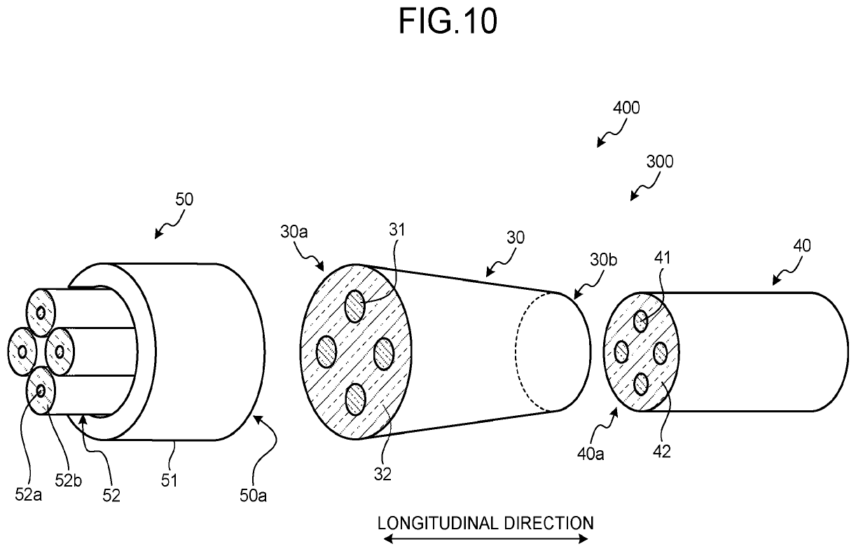

FIG. 10 is a schematic diagram illustrating an optical fiber connection structure according to a seventh embodiment. In an optical fiber connection structure 400, an end face 50a of an optical fiber fan-in/fan-out device 50 has been connected additionally to the first end face 30a of the pitch converter 30 of the optical fiber connection structure 300 according to the six embodiment. The connection is achieved by, for example, fusion splicing, but may be achieved by physical contact instead.

The optical fiber fan-in/fan-out device 50 includes a glass capillary 51 and four optical fibers 52. The four optical fibers 52 are, for example, single mode optical fibers and each have a core portion 52a and a cladding portion 52b. The four optical fibers 52 have been bundled together, inserted in the glass capillary 51 and fixed therein so that the core portions 52a are arranged, at the end face 50a, in a square lattice form matching that of the plurality of core portions 31 at the first end face 30a of the pitch converter 30. The four core portions 52a and the four core portions 31 have been respectively connected to each other.

Optical fiber fan-in/fan-out devices are generally manufactured by bundling optical fibers and inserting and fixing the bundled optical fibers in a glass capillary. If an optical fiber fan-in/fan-out device connected to a multi-core fiber having a small core pitch like the coupled multi-core fiber 40 is to be manufactured, optical fibers to be bundled together need to be optical fibers having a small diameter of, for example, 20 μm. In this case, the optical fibers having the small diameter are difficult to be inserted in the glass capillary and the optical fiber fan-in/fan-out device is thus difficult to be manufactured.

However, in the optical fiber connection structure 400, the optical fiber fan-in/fan-out device 50 is connected to the coupled multi-core fiber 40 via the pitch converter 30. The optical fiber connection structure 400 formed thereby includes the optical fiber fan-in/fan-out device 50 using the optical fibers 52 having a larger diameter, for example, 30 μm, is more easily manufactured, and is thus more easily obtained.

In the above described embodiments, the multi-core fiber, the coupled multi-core fiber, and the pitch converter have their core portions arranged in a square lattice form or a hexagonal close-packed lattice form, but the core portions may be arranged in any other form, such as, for example, a circular form.

Furthermore, in the above described embodiments, the pitch converter has the diameter decreasing portion over the entire length from the first end face to the second face, but part of the length from the first end face to the second end face may be a diameter decreasing portion and the rest of the length may correspond to a constant diameter portion having a constant cladding diameter.

Furthermore, in the above described fifth embodiment, the pitch converter, the multi-core fiber, and the coupled multi-core fiber are connected in this order, but the pitch converter, the coupled multi-core fiber, and the multi-core fiber may be connected in this order instead.

The present disclosure enables provision of a multi-core fiber with a higher core density and less inter-core crosstalk. Differences among core pitches in such multi-core fibers may be made less than those in fiber components, such as fiber bundles, and thus positioning in connection between the multi-core fiber and a light emitting or receiving element, for example, may be done comparatively easily. Furthermore, a pitch converter may increase core pitches collectively and thus facilitates: connection between a multi-core fiber having a comparatively small core pitch and a multi-core fiber having a comparatively large core pitch; and fabrication of an optical fiber connection structure. As a result, handleability and operability of the multi-core fiber having the small core pitch and optical fiber connection structure are able to be improved.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A multi-core fiber comprising:
a plurality of core portions; and
a cladding portion surrounding outer circumferences of the plurality of core portions and having a refractive index lower than a maximum refractive index of the plurality of core portions, wherein
the multi-core fiber has a mode field diameter of 5 μm or smaller at a wavelength of 1550 nm,
the multi-core fiber has a core pitch of 20 μm or smaller, the core pitch being an interval between centers of nearest neighboring ones of the plurality of core portions in a cross section orthogonal to a longitudinal direction,
the multi-core fiber has inter-core crosstalk of −20 dB/km or less, and
the multi-core fiber has a macrobending loss of 0.1 dB/m or less at the wavelength of 1550 nm when the multi-core fiber is bent at a radius of 5 mm.

2. The multi-core fiber according to claim 1, comprising four or more of the plurality of core portions that are arranged in a square lattice form in the cross section orthogonal to the longitudinal direction.

3. The multi-core fiber according to claim 1, comprising three or more of the plurality of core portions that are arranged in a hexagonal close-packed lattice form in the cross section orthogonal to the longitudinal direction.

4. The multi-core fiber according to claim 1, wherein the maximum refractive index of the plurality of core portions has a relative refractive index difference of 2% or more with respect to the refractive index of the cladding portion.

5. The multi-core fiber according to claim 1, having a W-shaped refractive index profile.

6. The multi-core fiber according to claim 1, having a trench-shaped refractive index profile.

7. A pitch converter comprising:
a plurality of core portions;
a cladding portion surrounding outer circumferences of the plurality of core portions and having a refractive index lower than the maximum refractive index of the plurality of core portions; and
a first end face and a second end face that are orthogonal to a longitudinal direction and opposed to each other in the longitudinal direction, wherein
the plurality of core portions and the cladding portion have a diameter decreasing portion that decreases in diameter in a tapered form to ⅔ of a diameter or less from the first end face to the second end face,
the pitch converter has a core pitch of 30 μm or larger, the core pitch being an interval between centers of nearest neighboring ones of the plurality of core portions at the first end face, and
the pitch converter has a core pitch of 20 μm or smaller, the core pitch being an interval between the centers of the nearest neighboring ones of the plurality of core portions at the second end face.

8. The pitch converter according to claim 7, wherein the maximum refractive index of the plurality of core portions has a relative refractive index difference of 2% or more with respect to the refractive index of the cladding portion.

9. The pitch converter according to claim 7, wherein the second end face has a diameter of 70 μm or larger and 125 μm or smaller.

10. An optical fiber connection structure comprising:
the pitch converter according to claim 7; and
a connecting multi-core fiber connected to the second end face of the pitch converter and including:
a plurality of core portions; and
a cladding portion surrounding outer circumferences of the plurality of core portions and having a refractive index lower than the maximum refractive index of the plurality of core portions.

11. The optical fiber connection structure according to claim 10, wherein the connecting multi-core fiber is a multi-core fiber comprising:
a plurality of core portions; and
a cladding portion surrounding outer circumferences of the plurality of core portions and having a refractive index lower than a maximum refractive index of the plurality of core portions, wherein
the multi-core fiber has a mode field diameter of 5 μm or smaller at a wavelength of 1550 nm,
the multi-core fiber has a core pitch of 20 μm or smaller, the core pitch being an interval between centers of nearest neighboring ones of the plurality of core portions in a cross section orthogonal to a longitudinal direction,
the multi-core fiber has inter-core crosstalk of −20 dB/km or less, and
the multi-core fiber has a macrobending loss of 0.1 dB/m or less at the wavelength of 1550 nm when the multi-core fiber is bent at a radius of 5 mm.

12. An optical fiber connection structure comprising:
a first multi-core fiber that includes a plurality of core portions and a cladding portion surrounding outer circumferences of the plurality of core portions and having a refractive index lower than the maximum refractive index of the plurality of core portions, has a core pitch of 20 μm or smaller, the core pitch being an interval between centers of nearest neighboring ones of the plurality of core portions in a cross section orthogonal to a longitudinal direction, and is a coupled multi-core fiber; and
a second multi-core fiber that is connected to the first multi-core fiber, includes a plurality of core portions and a cladding portion surrounding outer circumferences of the plurality of core portions and having a refractive index lower than the maximum refractive index of the plurality of core portions, has a core pitch of 20 μm or smaller, the core pitch being an interval between centers of nearest neighboring ones of the plurality of core portions in a cross section orthogonal to a longitudinal direction and being equal to the core pitch of the first multi-core fiber, and is an uncoupled multi-core fiber having inter-core crosstalk of −20 dB/km or less.

13. The optical fiber connection structure according to claim 12, wherein the second multi-core fiber is a multi-core fiber comprising:
a plurality of core portions; and
a cladding portion surrounding outer circumferences of the plurality of core portions and having a refractive index lower than a maximum refractive index of the plurality of core portions, wherein
the multi-core fiber has a mode field diameter of 5 μm or smaller at a wavelength of 1550 nm,
the multi-core fiber has a core pitch of 20 μm or smaller, the core pitch being an interval between centers of nearest neighboring ones of the plurality of core portions in a cross section orthogonal to a longitudinal direction,
the multi-core fiber has inter-core crosstalk of −20 dB/km or less, and
the multi-core fiber has a macrobending loss of 0.1 dB/m or less at the wavelength of 1550 nm when the multi-core fiber is bent at a radius of 5 mm.

14. The optical fiber connection structure according to claim 12, wherein the first multi-core fiber and the second multi-core fiber have approximately a same cladding diameter.

15. The optical fiber connection structure according to claim 12, further comprising:
a pitch converter connected to the first multi-core fiber or the second multi-core fiber, comprising:
a plurality of core portions;
a cladding portion surrounding outer circumferences of the plurality of core portions and having a refractive index lower than the maximum refractive index of the plurality of core portions; and
a first end face and a second end face that are orthogonal to a longitudinal direction and opposed to each other in the longitudinal direction, wherein
the plurality of core portions and the cladding portion have a diameter decreasing portion that decreases in diameter in a tapered form to ⅔ of a diameter or less from the first end face to the second end face,
the pitch converter has a core pitch of 30 μm or larger, the core pitch being an interval between centers of nearest neighboring ones of the plurality of core portions at the first end face, and
the pitch converter has a core pitch of 20 μm or smaller, the core pitch being an interval between the centers of the nearest neighboring ones of the plurality of core portions at the second end face.

16. An optical fiber connection structure comprising:
the pitch converter according to claim 7; and
a first multi-core fiber that is connected to the second end face of the pitch converter, includes a plurality of core portions and a cladding portion surrounding outer circumferences of the plurality of core portions and having a refractive index lower than the maximum refractive index of the plurality of core portions, has a core pitch of 20 μm or smaller, the core pitch being an interval between centers of nearest neighboring ones of the plurality of core portions in a cross section orthogonal to a longitudinal direction, and is a coupled multi-core fiber, wherein
the pitch converter at the second end face and the first multi-core fiber have approximately the same cladding diameter.

17. A method of manufacturing the optical fiber connection structure according to claim 12, the method comprising:
fusion splicing the first multi-core fiber and the second multi-core fiber; and
additionally heating a portion that has been fusion spliced and making a mode field diameter of the plurality of core portions of the first multi-core fiber and a mode field diameter of the plurality of core portions of the second multi-core fiber closer to each other.
